(19) United States
(12) Patent Application Publication
(10) Pub. No.: US 2023/0206218 A1
(43) Pub. Date: Jun. 29, 2023

(54) Access Control Systems and Methods for On-line Services

(71) Applicant: 12948231 CANADA INC., Saint-Colomban (CA)

(72) Inventor: Christopher Defour, Saint-Colomban (CA)

(21) Appl. No.: 17/561,102

(22) Filed: Dec. 23, 2021

(51) Int. Cl. G06Q 20/36; H04L 9/40

(52) U.S. Cl. CPC G06Q 20/3674; H04L 63/083

(57) ABSTRACT

Provided are devices and methods to provide access management such as for an online service or a secured location. In an embodiment, access management provides or denies access to a user in accordance with user credential information determined for the user, the user credential information indicating that the user is a provable holder of a threshold amount of a particular type of digital asset. Balance information is obtained from blockchain information, for example, by one or more methods, responsive to how a user holds/transacts their digital assets. The methods are responsive to use of different wallet types or exchange services. Credentials can be determined periodically or responsive to user activity. An example online service is a chat room for provable holders of cryptocurrency. Chat functions related to the particular type of digital asset can be permitted or denied using the access management.

### FIELD

The present disclosure relates to computer security and determining user credentials, etc. and more particularly to access control systems and methods for on-line or other services and physical access.

### BACKGROUND

On-line services are provided from a service provider to a service receiver via network communications such as Internet communications. Through a process of access management, a service provider may control access to at least some services to only those service receivers who are authorized to receive such services (e.g. authorized users). In an example, policies are used by an access management process to determine a particular authorized user's authorization to limit the authorized user to receiving some services or service functions and not others offered by the service provider. An example of an on-line service is a chat room service and examples of service functions are viewing conversation threads in a particular chat room and starting a new conversation thread in a particular chat room. Access to some chat rooms of the service provider may be made available to all users for viewing conversation threads while access to other chat rooms or to starting a new conversation thread in a chat room may be limited only to certain authorized users who meet established credentials (e.g. established in a policy for that chat room or that chat room's service function).

Databases are useful to store information establishing a user's credentials with which to determine authorization for online services. Blockchain-based databases are used to store digital assets such as cryptocurrencies, non-fungible tokens (NFTs), etc. and provide an immutable ledger for verifying information stored in the database.

It is desirable to provide access control to on-line services that evaluates as a user's credential information stored in one or more blockchains.

### SUMMARY

Provided are devices and methods to provide access management such as for an online service or a secured location. In an embodiment, access management provides or denies access to a user in accordance with user credential information determined for the user, the user credential information indicating that the user is a provable holder of a threshold amount of a particular type of digital asset. Balance information is obtained from blockchain information, for example, by one or more methods, responsive to how a user holds/transacts their digital assets. The methods are responsive to use of different wallet types or exchange services. Credentials can be determined periodically or responsive to user activity. An example online service is a chat room for provable holders of cryptocurrency. Chat functions related to the particular type of digital asset can be permitted or denied using the access management.

In an embodiment, there is provided a computing device comprising a processor and a storage device coupled thereto, the storage device storing instructions, which when executed by the processor, configure the computing device to: perform access management to control on-line access to an on-line service or physical access to a secured location, the access management providing or denying access to a user in accordance with user credential information determined for the user, the user credential information indicating that the user is a provable holder of a threshold amount of a particular type of digital asset.

In an embodiment, the instructions when executed configure the computing device to determine the user credential information by obtaining digital asset balance information for instances of the particular type of digital asset stored to a blockchain by or on behalf of the user. In an embodiment, the instructions when executed configure the computing device to, any of: obtain the digital asset balance information and determine the user credential information periodically; and obtain the digital asset balance information and determine the user credential information in response to a request for access received. In an embodiment, the instructions when executed configure the computing device to obtain the digital asset balance information using respective balance determining methods as enrolled by the user and respective user method data for each of the respective balance determining methods as enrolled.

In an embodiment, the respective balance determining methods comprise any of: a software wallet method to determine digital asset balance information from one or more accounts maintained by the user using a software wallet and wherein the respective user method data comprises software wallet information for the user; a hardware wallet method to determine digital asset balance information from one or more accounts maintained by the user using a hardware wallet and wherein the respective user method data comprises hardware wallet information for the user; a web3 wallet method to determine digital asset balance information from one or more accounts maintained by the user using a web3 wallet and wherein the respective user method data comprises web3 wallet information for the user; a first exchange service method to determine digital asset balance information from one or more accounts maintained by the user using a first exchange service, the first exchange service having an API and wherein the respective user method data comprises first exchange service information for the user; and a second exchange service method to determine digital asset balance information from one or more accounts maintained by the user using a second exchange service, the second exchange service not having an API and wherein the respective user method data comprises second exchange service information for the user.

In an embodiment, the instructions when executed configure the computing device to enroll the user in association with the particular type of digital asset including receiving respective user method data for each respective balancing determining method to be used to determine a total amount of the particular type of digital asset.

In an embodiment, the threshold amount is a count of instances of the particular type of digital asset or an equivalent currency value thereof.

In an embodiment, the access management controls access to an on-line service comprising a chat room service. In an embodiment, the chat room service provides services responsive to topics, the topics comprising types of digital assets and wherein the access management controls access to a chat room service associated with the particular type of digital asset. In an embodiment, the access management controls access to a function associated with the particular type of digital asset, the function comprising any of: adding a new chat room associated with the particular type of digital asset; adding a new conversation in a chat room associated with the particular type of digital asset; and replying to a conversation associated with the particular type of digital asset.

In an embodiment, the threshold amount of the particular type of digital asset is a first threshold amount of a first particular type, wherein the user credential information further includes information to indicate that the user is a provable holder of a second threshold amount of a second particular type of digital asset and wherein access management provides or denies access to the user in accordance with whether the user holds respective threshold amounts of one, the other or both of the first particular type and second particular type of digital asset.

In an embodiment, the particular type of digital asset is a particular type of cryptocurrency or a particular type of non-fungible token (NFT) such as one compliant with the ERC-720 technical standard for NFTs (for example).

Computer implemented method and computer program product aspects are also disclosed.

### BRIEF DESCRIPTION OF THE DRAWINGS

FIG. 1 illustrates a network architecture providing an on-line service to authorized users where authorization is determined from information stored to a plurality of blockchain-based databases, in accordance with an embodiment.

FIGS. 2A, 2B and 3 are flowcharts of operations of a computing device (e.g. a server) of FIG. 1 providing an on-line service in accordance with an embodiment.

FIGS. 4A, 4B, 5A and 5B are representations of graphical user interfaces of an online service in accordance with respective embodiments.

FIG. 6 illustrates a network architecture providing physical access to allow an individual to enter a secured location where authorization is determined from information stored to a plurality of blockchain-based databases, in accordance with an embodiment.

FIG. 7 is a flowchart of operations of a computing device (e.g. a server) of FIG. 6 providing access management in accordance with an embodiment.

### DETAILED DESCRIPTION

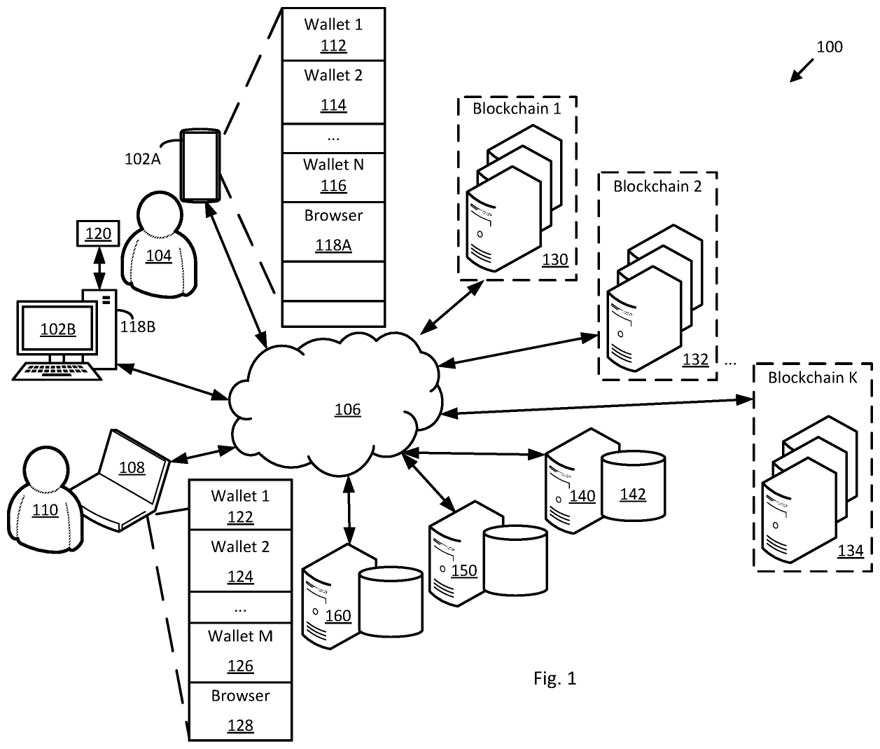

FIG. 1 illustrates a network architecture 100 for providing an on-line service to authorized users where authorization is determined from information stored to a plurality of blockchain-based databases, in accordance with an embodiment. Network system 100 shows a first user device 102A operated by a user 104 which device 102A is coupled to a network 106 and a second user device 1026 also coupled to network 108 and operated by user 104. Further shown is a third user device 108 coupled to network 106 and operated by a second user 110.

Each of the user devices 102A and 108 stores a plurality of wallet applications (e.g. “software wallets”) for interacting with respective blockchain networks to perform blockchain transactions. User device 102A is configured with a plurality (N) of wallets, namely, Wallet 1 112, Wallet 2 114 . . . Wallet N 116. User device 108 is configured with a plurality (M) of wallets, namely, Wallet 1 122, Wallet 2 124 . . . Wallet M 126. M need not equal N and though not shown, in an embodiment, a user device configured for blockchain transactions may have a single wallet. Each of the user devices 102A, 1026 and 108 is configured with a browser application (e.g. 118A, 118B and 128) such as for receiving services via web-based protocols.

User device 1026 is coupled to a hardware wallet 120 comprising a storage device (e.g. a solid state device (SSD) or in accordance with other technology such as non-volatile cryptographic memory chips) that is selectively coupled to device 102B. Hardware wallet 120 is coupled to device 102B when it is desired to perform a blockchain transaction using a key stored to the hardware wallet 120, as is known. Typically a hardware wallet is coupled to a computing device with communication capabilities. A blockchain transaction is generated using the computing device. The transaction is signed by the computing device using a key stored to the hardware wallet. In an example, the transaction request is generated using a browser interface, which may be acted upon using an interface provided by the supplier of the hardware wallet (for example), with the transaction signing step carried out entirely within the hardware wallet device. When the transaction is finalized, the hardware wallet 120 is decoupled from the computing device 102B to isolate the stored keys (and any other data that may be stored thereon) from being accessed via the computing device. Hardware wallets are also referred to as “cold storage”. Hardware wallets include the Trezor™ wallet of SatoshiLabs s.r.o, Prague, Czech Republic and Ledger™ wallet of Ledger SAS, Paris, France, among others.

Network 106 is coupled to a plurality (K) of blockchain networks, namely Blockchain 1 130, Blockchain 2 132, . . . Blockchain K 134. K need not equal M or N. Network 106 is further coupled to a server 140 providing the on-line service, such as an on-line chat service, to authorized users such as first user 104 and second user 110 via their respective devices 102A and 102B, and 108.

User device 102A is shown as a smartphone, a type of mobile computing device while user device 110 is shown as a laptop, another type of mobile computing device. User device 102B is shown as a desktop/personal computer (PC). Other computing device types may be used to engage in blockchain transactions, receive the on-line service, or both. That is, some may only communicate with one or more blockchains and some may only communicate for the on-line service. Any of the user computing devices need not be mobile devices. Including those shown, user computing devices can further include, but are not limited to, a tablet, a set top box, a game console, a smart TV, a server, etc. In the embodiment, user 104 receives the on-line service from either or both of user devices 102A and 102B but communicates for blockchain transactions using user device 102A.

Each of the respective blockchain networks Blockchain 1 130, Blockchain 2 132, . . . Blockchain K 134 maintains respective crypto assets such as coins and tokens, which may include non-fungible tokens, associated with respective user accounts that are controlled by cryptographic keys (e.g a private and public key (PPK) pair). The blockchain networks maintain immutable ledgers of blockchain transactions, writing groups of new transactions to additive blocks that are cryptographically signed. The networks comprise a plurality of nodes (e.g. servers) that perform the transaction processing to reach a form of consensus and the transactions are processed using a respective proof of work protocol adopted by the respective blockchain network. Further, in accordance with the transaction and processing protocols, the transactions are typically public (e.g. open to public inspection) but account holder information is generally private, unless an account holder chooses to make account holder information available. Popular blockchains include the Bitcoin network, the Ethereum network, The Binance network, and the Litecoin network, among others.

Wallet applications are useful to generate and communicate blockchain transactions such as in accordance with a respective transaction protocol established by a respective blockchain. Typically, a wallet application maintains at least one pair of keys for such transactions, but may manage hundreds of pairs of keys. Wallets also provide an interface to obtain and display or otherwise present account balance (e.g. coin balance or token balance, or a combination of the two) information from one or more accounts on a respective blockchain. In some embodiments, a wallet is configured to work with two or more different blockchains each having different protocols, coins, tokens, etc. Wallet applications include Jaxx™ wallet of Decentral Inc., Toronto, Canada and Exodus™ wallet of Exodus Movement, Inc., Omaha, N. Dak., among others.

Network 106 is further coupled to a server 150 providing blockchain exchange services on behalf of exchange users, for example, to perform transactions with a respective blockchain and to hold crypto assets on behalf of the exchange users and/or exchange coin of one type for coin of another or exchange coin for fiat currency or vice versa. An exchange service is an intermediary service between a user and the blockchain. Examples of exchange services include Kraken™ exchange services of Payward, Inc., San Francisco, Calif. and Binance™ exchange services of Binanace Holdings Limited, Grand Cayman, Cayman Islands.

In an embodiment, exchange users comprise one or more of users 104 and 110 who communicate with server 150 (e.g. via a respective user device) to perform blockchain transactions and server 150 may maintain account balance information for such one or more users. In one embodiment, a user (e.g. 104) uses one of the N wallets for some transactions, uses hardware wallet 120 for some and uses exchange services of server 150 for other transactions. These wallet and exchange service transactions associated with user 104 may, in an embodiment, relate to a same blockchain network but wallet and exchange service transactions relate to different accounts on the same blockchain. That is, the exchange service transactions on the blockchain relate to exchange service accounts. Similar to a financial institution, an exchange service maintains its own accounts (e.g. deposit accounts) and coin or token (i.e. digital asset) balances associated with these accounts (e.g. deposit account balances) and users of such a service do not have claims to specific instances of coins but to amounts held on behalf of the user. Intermediary exchange services may hold a balance of coins for its own behalf and sell coins to users for example in exchange for fiat currency. The intermediary exchange services may maintain such coins in its accounts on behalf of the user or may transfer the coins to a user controlled account (e.g controlled by a user wallet). The user may maintain the account (e.g. via a wallet application, for example) or transfer the coin to another intermediary exchange service (not shown) to maintain the coin, for example, in a risk mitigation strategy.

Another type of wallet that users of computing devices, such as but not limited to device 108, use for blockchain transactions are web3 wallets that interact with web page contents using a browser plugin (e.g. an extension written in JavaScript™ of Oracle America, Inc., etc.). An example of a web3 wallet is the Metamask™ wallet of Consensys Software Inc. Such wallets are generally used on desktop devices (e.g. laptop or PC, etc.) rather than a mobile device (e.g. smartphone or tablet).

In an embodiment, network 106 is further coupled to server 160 providing blockchain platform services, for example, via which server 160 blockchain information is obtained in a simplified manner. That is, server 160 provides one or more application programming interfaces (APIs) with which to obtain blockchain information. In an embodiment, for a particular blockchain (e.g. one of 130, 132 and 134), respective APIs are provided by the service to obtain blockchain address information, balance information, etc. Server 160 can provide respective APIs for more than one blockchain. An example of a blockchain platform service is Alchemy™ (a trademark of AlchemyAPI, Inc., San Francisco, Calif.)

In accordance with an embodiment, server 140 can obtain blockchain information from one or more of the blockchains 130, 132 and 134 via server 160. Though not shown, network 106 can be connected to more than one such server providing blockchain platform services. Server 140 can obtain particular digital asset balance information for users 104 and 110 for respective digital asset addresses controlled by the respective users using their wallets. Such wallets can comprise any of software wallets, hardware wallets, and web3 wallets.

In accordance with an embodiment, through a process of access management, server 140 controls access to at least some services so that only users who are authorized receive such services. In an example, policies are used by an access management process to determine a particular authorized user's authorization to limit a particular user to receiving only services (e.g. where services include particular service functions) where the user is authorized. The policies may provide access to some services but not others offered by the service provider for example. In an embodiment, access to some chat rooms of the service provider is made available to all users for viewing conversation threads while access to other chat rooms or to starting a new conversation thread in a chat room is limited only to certain authorized users who meet established credentials (e.g. established in a policy for that chat room or that chat room's service function).

In an embodiment, server 140 determines (e.g. obtains and evaluates) user credential information to determine whether a user (e.g. 104, 110) of the on-line service provided by server 140 is an authorized user. In an embodiment, at least some of the user credential information is determined from information stored to one or more of the blockchain networks 130, 132 and 134 or intermediary service server 150 or both. In an embodiment, the information stored is associated with the user. In an embodiment, for a particular type of digital asset, server 140 uses respective balance determining methods associated with the particular type of digital asset as well as user method data for the particular type of digital asset.
In an embodiment, the service offered by server 140 comprises a website that hosts an online software platform for cryptocurrency enthusiasts to connect and chat with one another. In an embodiment, users chat in rooms that are dedicated to a particular cryptocurrency or token. In an embodiment, users chat in rooms that are dedicated to a combination of several cryptocurrencies and/or tokens.

A goal of the service is to provide an environment to facilitate chat between users who are provable holders of a certain quantity (e.g. a threshold amount) of a Digital Asset, which addresses the problem of users who have “nothing at stake” participating in conversations and engaging in disruptive behaviour. This is substantially different from chat platforms where users can either join any room, or they must be invited, or have a password. In an embodiment, user credential information comprises proof that a particular user holds a threshold amount of a particular Digital Asset, whether in terms of a count of the asset, a value (e.g. in a fiat currency) or a combination of count and value.

For example, for coins, the threshold amount is a quantity of coins (e.g. at least X number of a particular coin type) or an amount that is equivalent to a quantity of fiat currency (e.g. at least a quantity of a particular coin type that has a fiat currency value of at least X amount of a particular fiat currency.) In an embodiment, user credential information comprises proof that a user has at least X Bitcoins (BTC). X may be a fraction of one unit, because most cryptocurrencies are divisible to many decimal places. In an embodiment, user credential information comprises proof that a user has a quantity of Ethereum coin (ETH) that is equivalent to at least Y US dollars (e.g. Y=US$100,000), where the price of Y is determined using an external reference price, such as that offered by CoinMarketCap.com and other cryptocurrency price indices.

In an embodiment, for example, for user credential information related to NFTs, user credential information comprises proof that a user holds a single particular NFT, which may be one of a plurality of acceptable NFTs. That is, the service maintains a list of approved NFTs and compares the user credential information to the approved list. If there is a match, access is given to the user. In an embodiment, the type of NFT is useful to determine which service features are provided to the user. For example the type of NFT can be associated to the blockchain on which the NFT is stored or the type of NFT can be associated to a characteristic or quality of a digital asset associated to the NFT (e.g. digital art NFTs, etc.). In an embodiment, the list of approved NFTs is maintained based upon a current valuation of the NFT. In an embodiment, the list of approved NFTs is updated from time to time, e.g. daily, weekly, monthly, or other period, which period need not be regular (e.g. every 2 to 3 days).

In an embodiment, NFT valuation is performed via a lookup communicating with one or more computing devices (not shown) that provide respective NFT valuation services, reporting recent trading prices, offer prices, etc.

In an embodiment, an online service (e.g. a person on behalf of such service) such as offered by server 140 mints or has minted NFTs on a selected blockchain for providing to users of the online service. A plurality of NFTs are minted with a view to transferring individual ones of these NFTs to respective individual users of the service. Each NFT may represent a user membership to the service. The online service may maintain a record (e.g. in a database 142 which provides a user and NFT record database maintained by the service) of which user holds which NFT of the plurality of NFTs. Each NFT on the selected blockchain may store a unique identifier that is also stored by the online service to the database 142. In an embodiment, a transfer of one NFT to a particular user is performed as a sale, requiring a transfer of coin or fiat currency in exchange for the NFT. In an embodiment, the NFT is only transferred upon proof that the user holds an amount of a particular coin. In accordance with the transfer, user information is associated to the NFT unique identifier in the database 142. In addition, user account information for the user on the selected blockchain (e.g. the receiving account in accordance with the NFT transfer on the selected blockchain) is also stored to the database 142 maintained by the service.

In an embodiment, the NFT comprises a digital asset such as a digital work of art or music, video, etc. The NFT may have value in addition to its membership function (e.g as user credential information). The NFT may change value in response to a valuation of the associated digital asset, for example, or may be valued as a requirement to access the on-line service of server 140, etc.

In an embodiment, the NFTs are transferable to another blockchain user, for example, as a sale. In an embodiment, transferring the NFT transfers membership in the service to the acquirer of the NFT. In an embodiment, the online service from time to time looks up the ownership of the particular NFT on the blockchain to confirm the user of the service remains the owner. If the NFT has been subsequently transferred (e.g. to an acquirer who may be another user of the selected blockchain or the same user but using a different blockchain account, for example), the online service prohibits access to the service (or a function thereof as previously noted) in response. In an embodiment, online service of server 140 provides an interface for the receiving user (acquirer) of the selected blockchain who receives the NFT by way of the subsequent transfer to request authorization as a user of the online services. In an embodiment, the online service verifies the acquirer's ownership of the NFT and verifies further user credential information that the acquirer owns a threshold minimum of a Digital Asset, which need not be on the same blockchain as the NFT. The service provides an interface to the acquirer to register the NFT transfer with the service for example, during an enrollment process to obtain a login and password and establish user credentials and prove that the acquirer meets the quantity or value threshold.

In an embodiment, should the user receiving the NFT originally (e.g. from the online service) cease to have such proof of a quantity or an equivalent value of a particular coin, the service may remove the NFT from its record as a membership/user credential. However, the NFT remains on the blockchain and may be otherwise used and transferred. Should the NFT be associated with a digital asset or other utility, the digital asset or other utility remains available to the holder, for example.

In an embodiment, the service minted NFTs are not associated with a digital or other asset. The NFTs provide membership related utility as described. In an embodiment, the service requires, for access control purposes, that an authorized user hold a minimum quantity of such NFTs, which quantity can be more than one such token.

in accordance with an embodiment where the service requires proof of a quantity or an equivalent value of a particular coin to provide access to the service or particular service functions, the result of applying this approach is chat rooms where the participants can be confident that the others in the room share their passion and can prove they have a certain amount of “skin the game” to ensure higher quality discussions and reduce spam. Unlike other forms of assets, virtual currencies can be proven using digital means, which is ideal for a digital communication platform, and marks a new era of networking.

There are many potential use cases for chat rooms where participants are all vetted as having a certain quantity (or an equivalent amount) of a specific digital asset. This could be useful for a brand to ensure that only their biggest fans (“whales”) are a part of certain conversations, such as promotional activities or consultations about the future directions of blockchain projects.

### Enrollment and Provisioning

A respective user (e.g. 104 or 110) of a device (e.g. 102A or 1028, or 108) enrolls to receive the on-line service, for example, browsing to a website (not shown) of the online service and registering to create a username and password such as to authenticate the user. The website is provided by server 140 or another server (not shown). In an embodiment, the user provides additional user information (e.g. via a web form provided by the server) that is stored by the online service (e.g. by server 140 to database 142) to define a user profile. For example, the user information may include contact information such as a mobile phone number to receive a text message to perform two factor authentication during sign on to receive the online services. To facilitate obtaining respective balances, the user provides user method information regarding each respective method to be used to obtain balance information for a particular type of digital asset. In an embodiment, an interface presents various respective types of digital assets. A user selects one (e.g. ETH) and via the same or another interface provides user method data for the respective balance determining method.

For software, hardware and web3 wallets, respective user method data typically comprises respective API information, for example, for use with an API of server 160. In embodiment, a user (e.g. 104) invokes one of their wallets that is used for transacting in the particular type of digital asset and where the user desires to enable the server 140 to determine balance information to define a wallet signature to provide to server 140. The wallet signature is defined using a private key stored to the wallet. The private key is retained by the user and not provided to server 140. The wallet signature is provided. From the wallet signature, the service then looks up the token balance(s) for the corresponding address that aligns with the signature. The server looks up the token balance by querying a blockchain node, or by querying an application programming interface (API) provided by a third-party that enables the query. Querying a blockchain node typically requires tracking all of the transactions and then filtering to just the address of interest, because the node must be sure that each transaction is valid. Querying a third-party API is simpler because the API abstracts the tracking steps that would be necessary to use a blockchain node. Either method can be used but in commercial practice an API would likely be the method of implementation chosen because these services are available at a low cost and provide reliable answers that do not involve developing software because the third-party API provider has already developed the software.

In embodiment, the user may provide more than one wallet signature from various wallets to enable balance determination. In an embodiment, the user can provide wallet signature information for more than one type of digital asset. Some wallets are useful to transact different digital assets such as on different chains and can provide respective signatures for each different type of digital asset. Enabling multiple wallet signatures enables the user-level functionality of proving a certain balance across the user's relevant wallets, rather than just one, which allows for a better security profile for users with use cases such as having one wallet for spending small amounts and a more secure wallet for storing larger quantities, which is accessed less frequently. This mode of operation enables higher security, and can be applied to any set of wallets that are supported.

As noted, a user can hold a particular type of digital asset using an exchange service such as offered by server 150. In an embodiment, server 150 provides an API for determining balance information. The balance determining method of server 160 can comprise this API. A user (e.g. 104) can provide user method data such as an applicable API key or keys or other user credential data as the case may be for the respective API that enables server 160 to invoke the API and obtain the balance information as permissioned by the user 104. In an embodiment, access tokens such as in accordance with OAuth protocol (e.g. see URL www.oauth.com/oauth2-servers/access-tokens/), represents the authorization of a specific application (e.g. of server 160) to access specific parts of the user's data at server 150. In an embodiment, an exchange service does not provide an API for determining balance information, per se. However, in an example of an exchange service, the service can store digital assets by way of respective exchange service customer addresses on a respective blockchain (e.g. and not in an omnibus account). In an embodiment of access management operations herein (e.g. for a respective balance determining method), such operations may obtain user method data comprising a user's address that the user obtained as a customer of the exchange service. The user address may be used to obtain a balance such as described, via a blockchain platform service or (e.g. more directly) from a blockchain node. In an embodiment, for example, where the exchange does not provide an API per se, user method data may comprise user credentials for the exchange service and a respective balance determining method can comprise using the credentials to access the exchange service, obtain the user's balance, for example, using invoking an exchange service function that returns balance information such as to a display screen and using screen scraping to obtain the balance information from the exchange service. Other techniques may be utilized, in accordance with the diversity of methods supported by online services for authentication and fetching of information pertaining to a user.

It will be understood that personally identifying information collection is limited. Certain user information may be collected such as a user email or contact information is employed for login (e.g. two factor authentication). But generally, private information is not obtained, other than blockchain addresses. Information can be safeguarded with typical SaaS platform security measures (e.g. doing connections only over TLS, user-authentication of database requests, etc.)

### Determining User Credential Information to Prove a Required Status

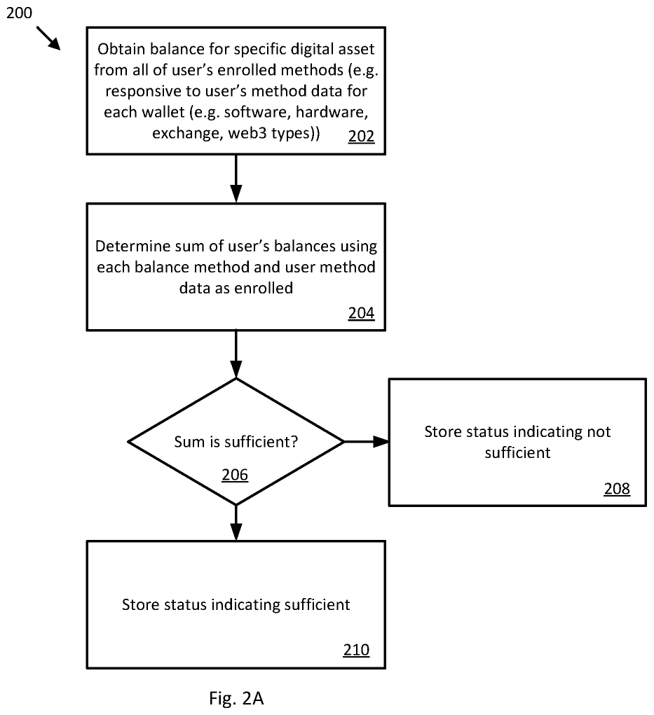

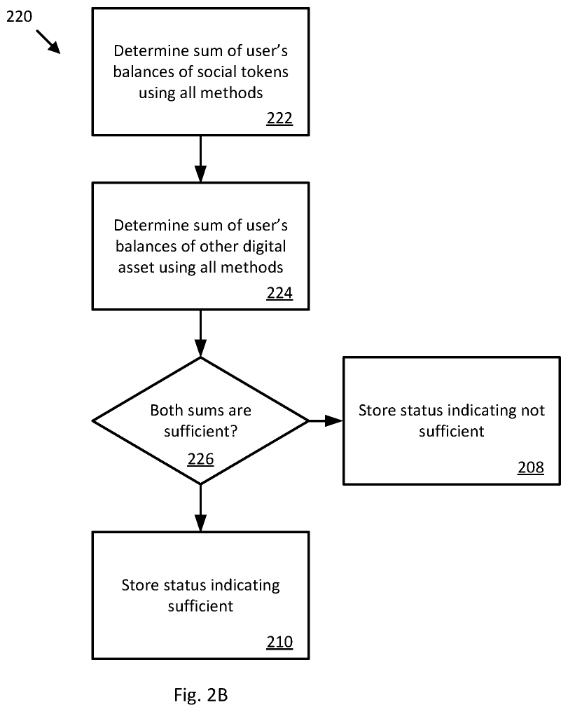

FIG. 2A is a flowchart of operations 200 of server 140 in accordance with an embodiment. Operations determine user credential information to prove a required status. For example, the user credential information comprises holding certain digital assets, the sufficiency of which determines whether the user qualifies as a particular or a general whale, or as a user who meets a certain threshold quantity pre-configured for a particular room.

At 202, operations obtain respective balances of a particular digital asset type (e.g. ETH) using respective balance determining methods enrolled by the user and in accordance with the respective user method data provided. As noted the user method data is responsive to the user's respective wallet(s) or exchange service.

At 204, the respective balances are summed to provide a current quantity. At 206 a determination is made whether the current quantity is sufficient (i.e. meets or exceeds a threshold minimum) to determine digital asset ownership status and obtain access to the on-line service. Such a determination, in an embodiment, comprises determining a current fiat currency equivalent for the current quantity or determining from a threshold minimum fiat currency amount that is reflected in a dynamic quantity of the particular asset being required. Though not shown, operations can comprise communicating with an exchange service or other service providing current exchanging pricing for the particular digital asset.

If a minimum threshold is not met, via no branch to 208, operations store a status that indicates the amount of digital asset is not sufficient. In an embodiment the status indicating insufficiency is useful to prevent access to the on-line service (or at least a portion thereof reserved for whales (i.e. those meeting the threshold, even if a threshold is small or any non-zero amount.) That is whale status is determined to be not true. If a minimum threshold is met, via yes branch to 210, operations store a status that indicates the amount of digital asset is sufficient. In an embodiment status is useful to permit access to the on-line service (or at least a portion thereof) reserved for whales such as a chat room related to the particular digital asset. That is whale status is determined to be true. Status data (e.g. reflecting the current determination of status for a respective digital asset) is stored to database 142 in association with the user, in an embodiment.

In an embodiment, operations 200 are performed for each type of digital asset enrolled by the user. In an embodiment, as described further herein below, operations are performed for each type of digital asset enrolled in the service and it is not necessary for the user to identify which digital assets are to be reviewed for the user.

In an embodiment, operations 200 are performed periodically. For example, operations 200 are performed (e.g. for each enrolled type of digital asset) every day, or every hour or some other fixed or non-fixed time interval. In an embodiment, operations 200 are event driven, for example, triggered by an activity of a user. In an example, the activity is a request to have access to an online service or service function requiring authorisation. In an embodiment, the periodicity is configurable. Periodicity can be chosen to be regular enough to thwart faking a balance by temporarily gaining control of someone else's digital asset.

FIG. 2B is a flowchart of operations 220 in accordance with an embodiment. FIG. 2B is similar to FIG. 2A. A difference relates to determining whether the user holds a quantity of a social token (e.g. an NFT). At 222, operations determine a sum of social tokens using all balance determining methods enrolled by the user (e.g. responsive to various user wallet types that user uses to hold the social token(s)). In an embodiment, social tokens are held in a single wallet and thus only a single balance determining method may be necessary using respective user method data provided by the user for the particular type of digital asset. In an embodiment, only one social token is required. At 224, operations determine the sum of balances of other digital assets (e.g. using respective balance determining methods and user method data from each of the wallets (including exchange service(s)) enrolled by the user). Digital assets, in an embodiment, include respective cryptocurrencies. At 226 a determination is made whether both of the sums are sufficient. The user must have sufficient social token and sufficient digital assets. If at 226 the determination is no (insufficiency in any one requirement), by no branch to 208 (e.g. similar to FIG. 2A), operations store a status indicating insufficient such as for use to prevent access to the service or a function thereof (e.g. access to a specific chat room is prevented). That is whale status is not true. If at 226 the determination is yes (i.e. sufficiency in all requirements), by yes branch to 210 (e.g. similar to FIG. 2A), operations store a status indicating status is sufficient such as for use to permit access to the service or a function thereof (e.g. access to a specific chat room is permitted). That is whale status is true.

In an embodiment, operations 220 are performed for each type of digital asset enrolled by the user that has the multiple requirements of a social token and other digital asset sufficiency. In an embodiment, as described further herein below, operations are performed for each type of digital asset enrolled in the service and it is not necessary for the user to identify which digital assets are to be reviewed for the user.

In an embodiment, operations 220 are performed periodically. For example, operations 220 are performed (e.g. for each enrolled type of digital asset, etc.) every day, or every hour or some other fixed or non-fixed time interval as described with reference to operations 200. In an embodiment, operations 220 are event driven, for example, triggered by an activity of a user. In an example, the activity is a request to have access to an online service or service function requiring authorisation.

In an embodiment, sufficiency comprises a respective quantity or equivalent value for the social token and for the other digital asset(s). Sufficiency may be in accordance with each respective digital asset. That is, a user may have sufficient BTC to be classified as a Bitcoin whale but insufficient ETH (or any other digital asset) for a respective whale status for Ethereum or that other respective digital asset whale status.

In an embodiment, the online service defines a general whale status for access to one or more services where sufficiency is an aggregate measure of a plurality of digital asset currencies. For example, online service may have a general whale status if the user has at least X amount (e.g. in quantity or an equivalent value) in the aggregate of a plurality of cryptocurrencies. For example, a minimum sum of coins or parts thereof or a minimum total equivalent fiat currency value from one digital asset or two or more different digital assets. In an embodiment, general whale status is responsive to a plurality from a defined set (e.g. qualifying balances must be from one or more of BTC, ETH, etc. currencies only).

### Access to Chat Room Services by Status

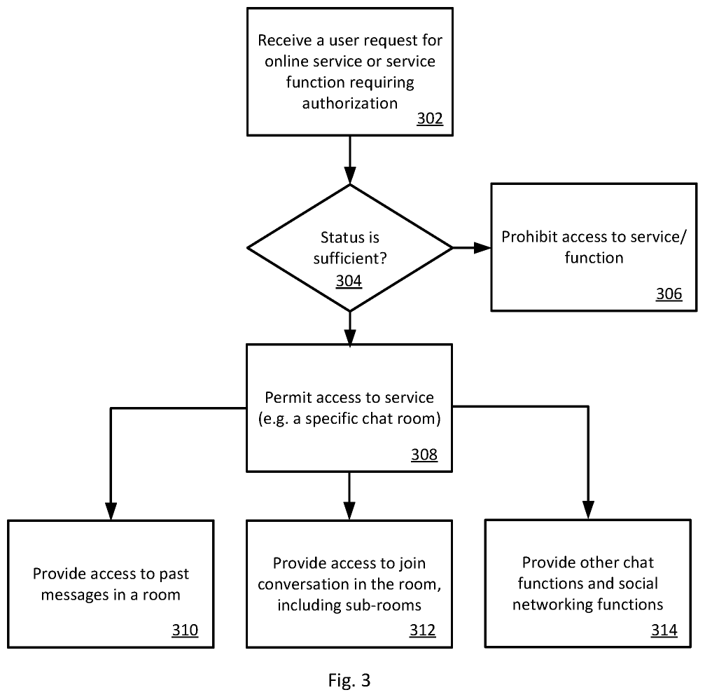

FIG. 3 is a flowchart of operations 300 which perform authorization to prevent or permit access to an online service (which may be a service function as noted herein) responsive to a status of the user. At 302 operations receive a user request (e.g. via a respective user device) for access to a service or function requiring authorization by status. At 304 a determination is made whether the status is true (e.g. via look-up in database 142). The status may be associated with a particular digital asset. If the status is not true, via no branch to 306, access is prevented. If the status is true, via yes branch to 308, access is permitted.

In the embodiment, operations providing access include any of providing access to past messages in a chat room (at 310); providing access to join a conversation in a chat room or sub-room of a chat room (312); and providing other chat functions and social networking functions (314).

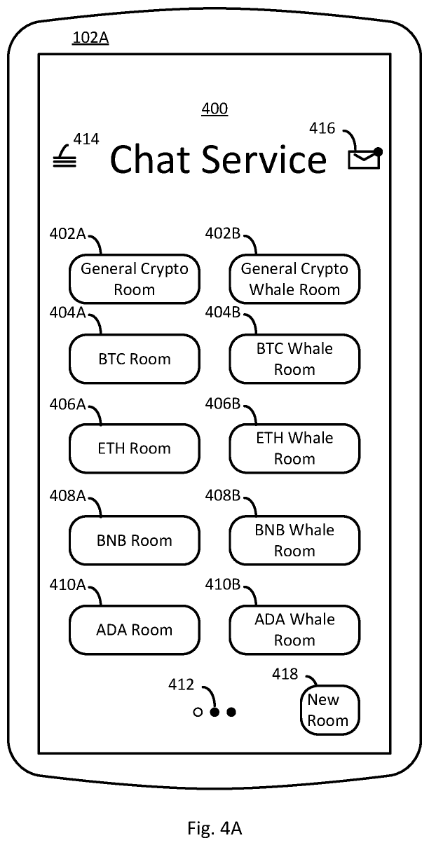

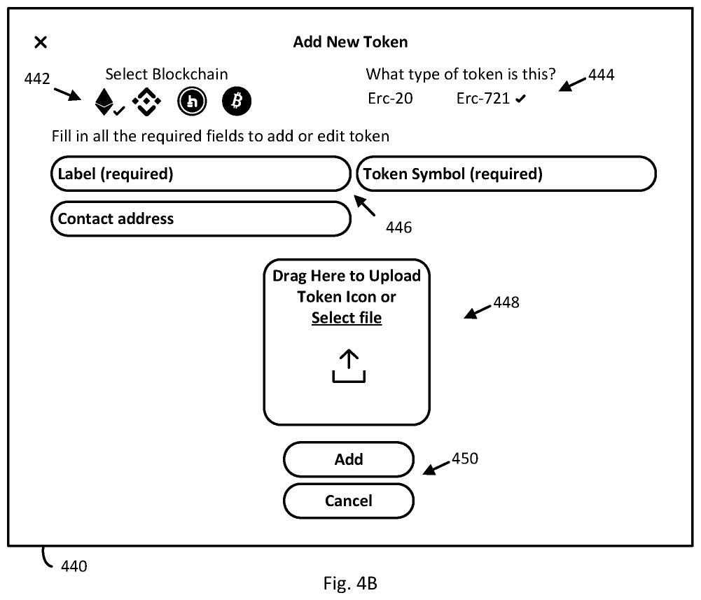

With reference to FIG. 4, there is shown device 102A presenting a graphical user interface (GUI) 400 for the online service of server 140, in accordance with an embodiment. The GUI 400 is presented via a web interface or native application for running on user device 102A, to present the online service or functions thereof to the user (e.g. 104). The user interacts with the GUI 400 to invoke the service/functions thereof. In the embodiment, the GUI 400 comprises a plurality of controls 402A, 402B, 404A, 404B, 406A, 406B, 408A, 408B, 410A and 410B for accessing different chat rooms. In the present embodiment, each of controls 402A, 404A, . . . 410A provide access to chat rooms that do not require whale status. That is, user credential information related to holding a sufficient amount of digital assets is not required. In the present embodiment, each of controls 402B, 404B, . . . 410B provide access to chat rooms that do require whale status. In the present embodiment, to access a general crypto whale room via control 402B requires a general whale status as previously described. In the present embodiment, to access each respective particular digital asset whale room (e.g. via respective control 404B, 406B, . . . 410B) requires a respective whale status for that digital asset as previously described. In an embodiment, any of the whale rooms (e.g. via respective controls 402B, 404B, 406B, . . . 410B) require social token and digital asset sufficiency as described. In an embodiment, any of the non-whale rooms (e.g. via respective control 402A, 404A, 406A, . . . 410A) require social token but not digital asset sufficiency.

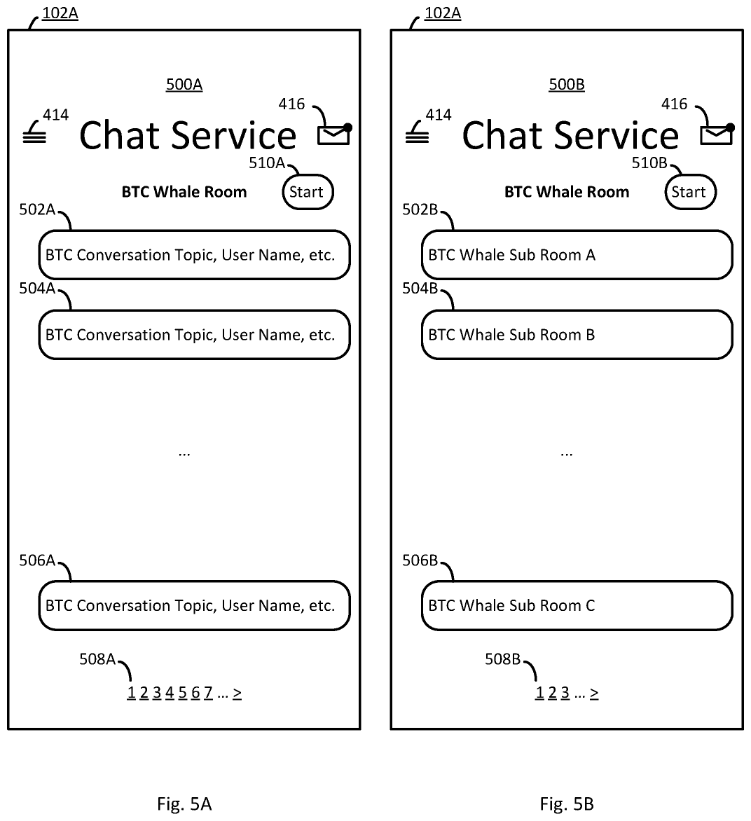

In an embodiment, any of the whale rooms (e.g. via respective controls 402B, 404B, 406B, . . . 410B) do not require social token or digital asset sufficiency as described to access the particular room; rather, within the particular room, and as further described with reference to FIG. 5A, in accordance with an embodiment, whale status is required to start a new conversation or to reply within an existing conversation.

With continued reference to FIG. 4A, GUI element 412 provides navigation information and relates to a gestural control (e.g. a swipe control (not visualized)) to navigate between GUI screens (e.g. as is known). Navigation to other screens facilitates access to other chat rooms for other digital assets (not shown). Control 414 provides a menu function such as to access a user profile interface for the user to edit user credential information, access a message interface to compose a message to another user, adjust settings such as for user selectable aspects of the GUI, etc. Control 416 provides direct access (e.g. via a respective GUI (not shown)) to notifications such as from the online service and/or private/direct messages from other users.

GUI 400 presents control 418 to start a new chat room, for example, for a new token (new type of digital asset). In an embodiment, adding a new token adds a new whale chat room. In an embodiment, control 418 is invokable only if the user has whale status such as according to any of the embodiments described for determining such status. However, in an embodiment, the user desiring to have a new token added (and a new room created) must prove the user has a certain quantity of the digital asset, or the user can pay a fee to the online service to have the room created. In effect, a user of the online service could pay the online service (e.g. via an e-commerce interface, etc.) to add a token and create a new room but the user wouldn't be able to participate in the chat room unless the user proves the user's balance like every other user. Operations to add a token and create the new room can be automated or can be performed by an administrator of the service, for example, after verification of payment received or in the ordinary course of performance of duties, etc. In an embodiment, a request to add a new token creates a new whale room and also creates a chat room open to users without whale status of the particular digital asset.

In an embodiment, the addition of a new token triggers status determining operations associated with the token. For example, in an embodiment, operations 200 or 220 are performed to determine respective user balances of the new token to determine whale status. In an embodiment, the online service provided by server 140 stores a list (or other construct) of instances of digital asset types (e.g. where a digital asset type is a type of coin, type of token, etc.) for evaluation by the server 140 by operations 200 or 220. For example, the list is stored in database 142. The list corresponds to respective chat rooms (e.g. whale and non-whale rooms) provided by server 140.

For any user who has enrolled one or more wallets with the service, operations 200 or 220 are performed for each of the different digital assets in the list to determine a respective user's status for each of the different digital assets. In an embodiment, a settings or user profile interface provided by the server enables a user to select which digital asset types are to be evaluated for a user. For example, consider where a user holds three types of digital assets but only wishes to have the server (e.g. service) evaluate two of the three, preferring not to be labelled as a whale for a particular one of the three asset types.

Without limitation, in an embodiment, it is anticipated that a creator of a new room directed to a particular digital asset (e.g. for which a room does not exist at the time of the request to create) can be a representative of the actual digital asset project (e.g a new blockchain from a new entity, or otherwise). For example, assume Token A was created by XYZ Corp Ltd. in New York City. XYZ Corp (e.g. via a device user on its behalf) can enroll in the online service and use the interface to pay a fee to create the Token A room. It is anticipated that such a user could easily prove a sufficient balance because they would hold a large amount of Token A as the promoters of it.

It will be understood that an administrator of the online use may unilaterally define new chat rooms such as by way of “out of band” operations, manually creating them on the administrative side of the software, without any proof of balance. For example, the company that operates the service can make rooms without having to prove to itself that it has the required tokens (but any user that joins the room does have to prove their balance).

FIG. 4B illustrates a GUI 440 provided by server 140 in accordance with an embodiment. GUI 440 provides various controls and input fields to add a new token. Controls 442 (e.g. a plurality of respective blockchain icons (e.g. logos) representing each of the blockchains supported by the service) are selectable to identify the blockchain on which the new digital asset is minted/transacted/maintained. Controls 444 are selectable identifiers (e.g. common abbreviated names) of the token standard used by the respective blockchain for implementing the new token. The examples shown, “ERC-20” and “ERC-721” relate to Ethereum standards. ERC-20 relates to fungible tokens and ERC-721 to non-fungible tokens. These standards identify, among other things, how account balances are obtained from the Ethereum blockchain for tokens implemented in accordance with the standard. In the embodiment illustrated, the service is enabled to read balances of fungible and non-fungible tokens, for example, to increase flexibility and applicability to digital assets more broadly.

Controls 446 provide data input fields for receiving text identifying a token label (e.g. a name), a token symbol (e.g. trading symbol, typically a few letters/characters denoting the token), and, optionally, a contact address such as for the promoters of the token. In an embodiment, the service has a predetermined threshold (e.g. a minimum number) of the new tokens that must be held to qualify as a whale. In another embodiment, not shown, there is an additional one of controls 446 (or another) that provides an input field to receive the threshold minimum.

Control 448 provides an input field to receive by way of drag and drop or file selection a graphical image comprising a token logo (e.g. an icon). The logo is useful when displaying token information, for example in a room name, a selection interface, message content or flare, etc. Controls 450 receive input to complete the addition or cancel the addition of a new token. Token information received can be stored in database 142. In an embodiment, before completing the addition of the new token to the service, server 140 confirms the accuracy and completeness of the information received. For example, server 142 searches database 142 to confirm that the new token is new and not one already established in the service. In an embodiment, server 142 performs operations such as third party information look-up, blockchain look-up (eg. via an API), exchange service look-up (e.g. via API), etc. to confirm the information is correct.

In an embodiment, completion of the new token addition permits creation of a new chat room or rooms, for example, a generally available chat room regardless of status and a whale room requiring whale status. In an embodiment, as discussed herein, a new room can be added for browsing regardless of status but some functions are limited to only whales within the context of the room.

Creation of such a room or rooms can be automated, for example using coding and interface templates that are provisioned using the information received via GUI 440. In an embodiment, the provisioning is partially automated. For example, an administrator of the service may provide input to complete provisioning before the new room goes live. As previously noted, the addition of a new token, in an embodiment, adds the token to a list of tokens which are evaluated for sufficiency to determine whale status.

FIG. 5A illustrates device 102A presenting a graphical user interface (GUI) 500A for the online service of server 140, in accordance with an embodiment. GUI 500A relates to a chat room interface for a particular whale room such as a BTC whale room accessed via control 402B. GUI 500A presents respective conversation thread controls 502A, 504A, . . . 506A to access respective conversations. Controls 508A provide navigational controls to access pages of conversations. In an embodiment, though not shown, conversations are selectively ordered such as by date, number of replies, an associated rating (e.g. positive votes received), awards received, etc. Conversation threads (e.g. conversation content, replies, respective user identification associated with the conversation threads, votes, and other thread information) are stored in database 142.

Control 510A, when invoked, starts a new conversation (e.g. via a GUI to compose a new conversation (not shown)). As noted in some embodiments, access to a particular whale room requires whale status while in other embodiments, access does not require whale status; rather whale status (e.g. relative to the chat room) is required to invoke control 510A. In some embodiments, GUI is (dynamically) responsive to whale status such that GUI 500A does not present control 510A if the user does not have the respective whale status (e.g. at least at the time of initial presentation of GUI 500A. The GUI may display the control but in a manner that shows the control is not active (e.g. masked/greyed out or in broken lines, etc.) It will be understood that the GUIs of the service can be configured such that any function requiring whale status to invoke the function is associated with a dynamic control that is only presented to function when whale status associated with the control is positively determined.

Though not shown invoking any of controls 502A, 504A and 506A presents a further GUI to display the conversation thread (e.g. the initial message from an originating user and any authorized replies received. Such a GUI comprises a reply control (not shown) to invoke a reply composition interface (also not shown). In an embodiment, invoking such a reply control (e.g. in association with a conversation thread within a whale room) requires whale status for an authorized reply. As a result, in some embodiments, non-whale status users may browse whale room conversations but are not authorized to start a new conversation or reply to an existing conversation.

FIG. 5B illustrates device 102A presenting a graphical user interface (GUI) 500B for the online service of server 140, in accordance with an embodiment. GUI 500B relates to a chat room interface for a particular whale room such as a BTC whale room accessed via control 402B. GUI 500B presents an interface to access respective sub-rooms via sub-room controls 502B, 504B, . . . 506B. Controls 508B provide navigational controls to access pages (e.g. screens) listing the sub-rooms. In an embodiment, though not shown, sub-rooms relate to respective (sub-)topics associated with the particular digital asset, for example. In an embodiment, the order of presentation of the sub-rooms on the pages (via respective controls such as 502B, 504B, . . . 506B) are selectively ordered such as alphabetically, by date (e.g. of creation, of latest conversation within the sub-room), number of conversations within the sub-room, an associated rating or popularity (e.g. responsive to a total of positive votes received for conversations within the sub-room compared to other sub-rooms), total of awards received, etc. Though not shown, invoking a control (e.g. 502B) for a sub-room opens a conversation thread interface within the sub-room, for example, similar to GUI 500A. Conversation content, replies, respective user identification associated with the conversation threads, votes, and other thread information are stored in database 142.

Control 510B, when invoked, starts a new sub-room (e.g. via a GUI to compose a new sub-room title (e.g. a topic (not shown)). The GUI for a new sub-room can be similar to GUI 440 in that controls are useful to provide input fields for the sub-room information. Once added, provisioning of the new sub-room may be automated such as by adapting coding and interface templates for a sub-room to use the information received. Database 142 can store the sub-room code and interface, etc.

As noted in some embodiments, access to a particular whale room requires whale status while in other embodiments, access does not require whale status; rather whale status (e.g. relative to the chat room) is required to invoke control 510B. In some embodiments, GUI 500B is (dynamically) responsive to whale status such that GUI 500B does not present control 510B if the user does not have the respective whale status (e.g. at least at the time of initial presentation of GUI 500B. The interface may display the control but in a manner that shows the control is not active (e.g. masked/greyed out or in broken lines, etc.) It will be understood that the GUIs of the service can be configured such that any function requiring whale status to invoke the function is associated with a dynamic control that is only presented to function when whale status associated with the control is positively determined.

Though not shown invoking any sub-room via controls 502B, 504B . . . 506B presents a further GUI to display the conversation thread (e.g. the initial message from an originating user and any authorized replies received. Such a GUI comprises a reply control (not shown) to invoke a reply composition interface (also not shown). In an embodiment, invoking such a reply control (e.g. in association with a conversation thread within a whale room) requires whale status for an authorized reply. As a result, in some embodiments, non-whale status users may browse whale room conversations but are not authorized to start a new conversation or reply to an existing conversation.

With reference again to FIGS. 4A, 5A and 5B, in an embodiment, control 416 provides access to a personal or direct message interface (not shown) to view and manage messages from other users of the on-line service. In an embodiment, whale status of respective sending users is useful to filter messages received for presenting via the interface. For example, messages can be filtered to order or remove messages from non-whale status users. The filter can be granular, for example, filtering to sort by or show only messages from whales status users holding a sufficient amount of a particular digital asset (e.g. sort by whale status of 10 most popular cryptocurrencies, show only messages from BTC whales, etc.)

In an embodiment, when user names are displayed within at least some of the GUIs, the user names are presented to distinguish whale and non-whale status. For example, user names are flared with digital asset symbols associated with respective digital assets (e.g. icons or abbreviations representing respective digital assets. Non-whales may be flared with non-bold or non-flashing symbols and whales with bold or flashing symbols, etc. Flaring may be selectable by the user (e.g. via a user profile editing interface) but access limited so that non-whale status users cannot select/invoke whale status flaring.

In an embodiment, a duration of a particular user's whale status is tracked. For example, the online service may track how long a user has had ETH whale status (e.g. following becoming a user of the service) and provide a reward such as a trophy or other recognition, including social tokens, etc. when one or more milestones are reached. Milestones may be months or years.

In an embodiment, milestones (and therefore reward triggers) relate to new whale room conversations started, whale room conversation replies made, whale room conversation positive votes received (e.g. on conversations and/or replies) from other users, etc.

Though the embodiments are described with reference to whales and non-whales, where a whale typically denotes a user holding a relatively large amount of a particular digital asset, the techniques, systems and methods described can be adapted to distinguish those holding any amount from those holding zero amount. In an embodiment, access management operations use a threshold that is an amount greater than zero. In an embodiment, more than one threshold is used, for example to distinguish those having some from those having none of the digital asset and to distinguish those who have a large amount (e.g. a whale) from others having less than the large amount threshold. In an embodiment, tiered services can be offered accordingly. For example, observer status can be provided to those with some quantity of the digital asset but greater participation status is reserved for those meeting or exceeding the larger amount threshold. Those having zero may be excluded. In another example, those having zero are given observer status, those with some are enabled limited participation (e.g. voting or commenting), while those meeting the larger amount threshold are enabled to originate, reply, vote, comment, etc.

It will be understood to a person of skill in the art that the sum of the user's balances is different depending on the input source. Operations to obtain respective balances of a particular digital asset use several methods that are responsive to the nature (e.g. type and provider) of the wallet. The different methods are unified by the operations to provide an aggregate balance that does not depend on the source. This allows a user to prove their balance no matter where they're storing it, which has been a problem in the industry to-date.

It will be further understood that the approach doesn't require a user to move their balance to a single wallet because, in the context of the service, the users aren't conducting transactions. The quantity of each cryptocurrency held is the only relevant consideration for determining access control, and the service doesn't need or perform any cryptocurrency transaction (e.g. a transfer). The aggregate balance is the only number that matters in terms of authenticating the user as someone permitted to access a particular room or other service function restricted to users who hold a threshold amount of a digital asset, including, for example, those who qualify as whales.

Physical Access Control in Accordance with Status

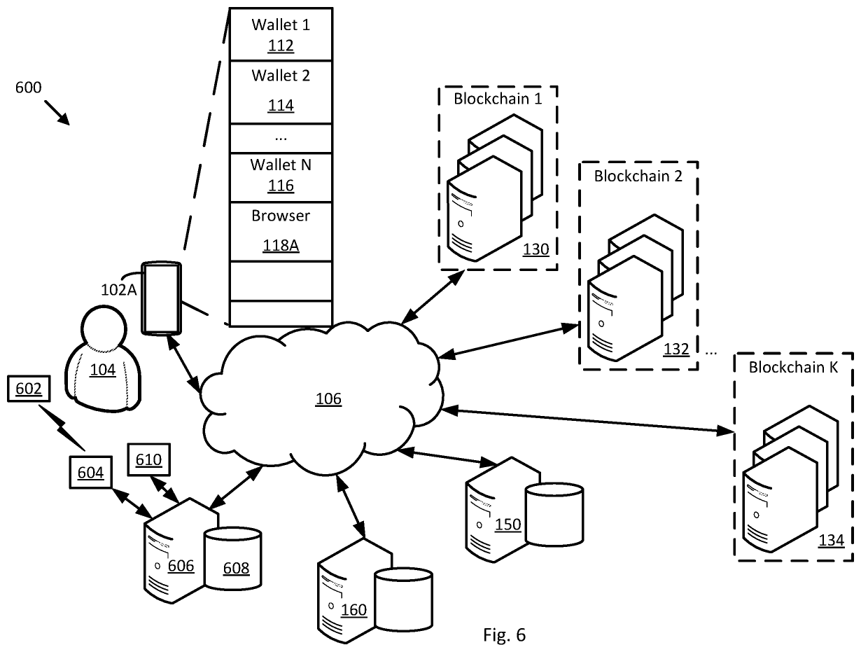

FIG. 6 illustrates a network architecture 600 providing physical access to an individual (e.g. user 104) where authorization is determined from information stored to any of a plurality of blockchain-based databases 130, 132, 134, and exchange services (e.g. only one service 150 is shown), in accordance with an embodiment. Physical access includes but is not limited to entering (or leaving) a secured location, operating a device, etc. In an embodiment, information is stored to a single blockchain-based database (e.g. 130) or single exchange service 150. In an embodiment, blockchain platform server 160 provides APIs to access blockchain information of blockchain 130 for example for wallet held digital assets.

In an embodiment, access status is determined for the individual in response to a minimum threshold amount of one or more digital assets held by the individual as stored to the plurality of blockchain-based databases 130, 132, 134, or to the exchange service 150.

FIG. 6 is similar to FIG. 1 but where FIG. 6 shows user 104 using an access device 602 such as a short range communication device (e.g. RFID, or other communication standard) to identify the user to a corresponding reading device 604 coupled to an access system 606 comprising a server or other computing device coupled to a database 608 or other datastore. Access system 606 is coupled to control an access device 610 (e.g. a physical security device, often electromechanical in nature), such as but not limited to a lock, a barrier, a door, a file drawer, etc. Typically, the access device 610 is in a normally closed, shut or locked, etc. position, which prevents access. The access system 606 commands the access device 610 to permit access.

In the embodiment shown, the short range communication device has data stored thereon that is communicated via the reading device 604, which data is linked to the user's identity in the database 608. The user's identity is linked to the user access status. Operations 200 and/or 220 are performed by access system 606 (or another on its behalf) to determine status periodically in accordance with an embodiment. User 104 enrolls the user's one or more wallets in the access system 606 in a similar manner as described with respect to enrolling to receive the on-line service of server 140.

In an embodiment, in place of the short range communication device 602, the user uses device 102A having data stored thereon for communicating with the reading device (e.g. via near field communications or another standard, including optical over the air communication). In an embodiment, in place of the short range communication device 602, the user presents biometric information such as face, iris, finger or other biometric user information and combinations thereof.

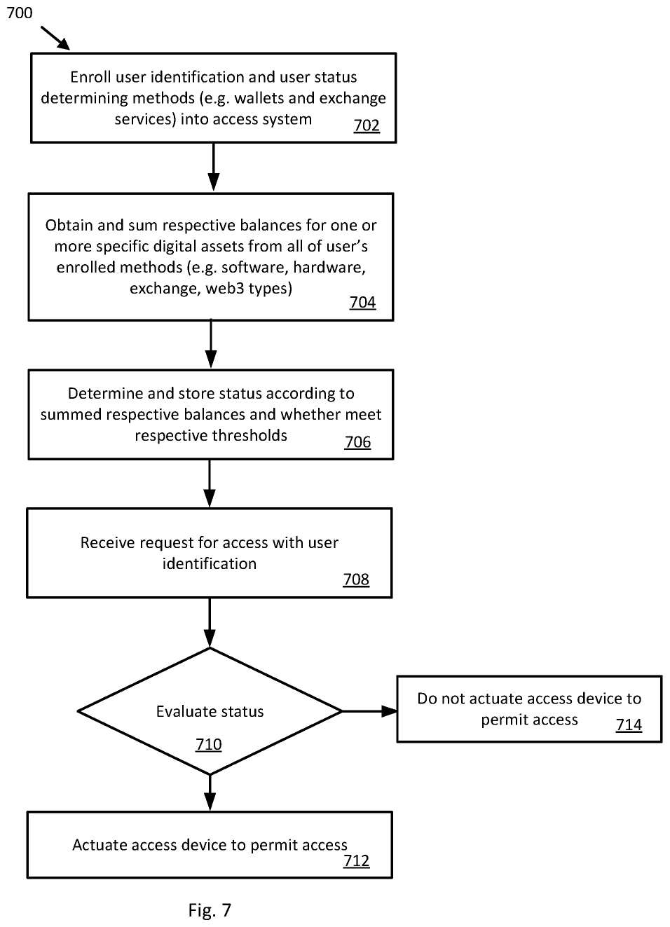

With reference to FIG. 7 showing a flowchart of operations of access system 606 in accordance with an embodiment, to enroll a user, access system 606 receives user information identifying the user and identifying methods (e.g. wallet or exchange service methods) to access the user's digital asset balances with which to determine status (at 704). At 704 and 706, periodically, status is determined in accordance with the respective amounts of one or more different digital asset types held by the user as determined using the methods to access the balances. In an embodiment, balances of respective same digital asset types (e.g. a same coin type) are summed together. A determination is made whether the respective amounts meet respective minimum thresholds. Each threshold may be a quantity (e.g. a count) or an equivalent fiat currency value. In an embodiment, the user is required to hold at least one token digital asset such as an access system token and a minimum threshold of a second digital asset such as a cryptocurrency coin.

At the time access is desired via the access system, a user presents identification to the access system via the reading device (708). The access system uses the identification to look-up the status and evaluate it (710). The access system actuates (712) or not (714) the access device 610 in accordance with the status to permit or prevent access.

Various computing devices described herein include but are not limited to personal computers, laptops, smartphones, tablets, workstations, and servers. Any of the computing devices described herein may comprise a processing unit with one or more processors, and a storage device. The storage device can comprise memory coupled to the processing unit to store instructions to configure the execution of the processor. The computing device may have or be coupled to input, output and/or input/output devices and systems. The computing device may have or be coupled to other storage devices (i.e. other than memory). Storage devices may take different forms and/or configurations, for example, as short-term memory or long-term memory. Storage devices may be configured for short-term storage of information as volatile memory, which does not retain stored contents when power is removed. Volatile memory examples include random access memory (RAM), dynamic random access memory (DRAM), static random access memory (SRAM), etc. Storage devices, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

The computing device typically comprises a communication system for communicating with other devices or systems or internally. The communications capabilities can include one or more wireless or wired capabilities. The features and operations herein may be implemented in software, hardware of combinations thereof. Software comprising instructions (e.g. Computer program code) for carrying out operations when executed by the processor may be written in any combination of one or more programming languages, e.g., an object oriented programming language such as Java, Smalltalk, C++ or the like, or a conventional procedural programming language, such as the “C” programming language or similar programming languages.

In addition to computing device aspects, a person of ordinary skill will understand that computer program product aspects are disclosed, where instructions are stored in a non-transitory storage device (e.g. a memory, CD-ROM, DVD-ROM, disc, etc.) to configure a computing device to perform any of the method steps or aspects described herein.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “include” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of the features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computing device comprising a processor and a storage device coupled thereto, the storage device storing instructions, which when executed by the processor, configure the computing device to:
perform access management to control on-line access to an on-line service or physical access to a secured location, the access management providing or denying access to a user in accordance with user credential information determined for the user, the user credential information indicating that the user is a provable holder of a threshold amount of a particular type of digital asset.

2. The computing device of claim 1, wherein the instructions when executed configure the computing device to determine the user credential information by obtaining digital asset balance information for instances of the particular type of digital asset stored to a blockchain by or on behalf of the user.

3. The computing device of claim 2, wherein the instructions when executed configure the computing device to, any of:
obtain the digital asset balance information and determine the user credential information periodically; and
obtain the digital asset balance information and determine the user credential information in response to a request for access received.

4. The computing device of claim 2, wherein the instructions when executed configure the computing device to obtain the digital asset balance information using respective balance determining methods as enrolled by the user and respective user method data for each of the respective balance determining methods as enrolled.

5. The computing device of claim 4, wherein the respective balance determining methods comprise any of:
a software wallet method to determine digital asset balance information from one or more accounts maintained by the user using a software wallet and wherein the respective user method data comprises software wallet information for the user;
a hardware wallet method to determine digital asset balance information from one or more accounts maintained by the user using a hardware wallet and wherein the respective user method data comprises hardware wallet information for the user;
a web3 wallet method to determine digital asset balance information from one or more accounts maintained by the user using a web3 wallet and wherein the respective user method data comprises web3 wallet information for the user;
a first exchange service method to determine digital asset balance information from one or more accounts maintained by the user using a first exchange service, the first exchange service having an API and wherein the respective user method data comprises first exchange service information for the user; and
a second exchange service method to determine digital asset balance information from one or more accounts maintained by the user using a second exchange service, the second exchange service not having an API and wherein the respective user method data comprises second exchange service information for the user.

6. The computing device of claim 1, wherein the instructions when executed configure the computing device to enroll the user in association with the particular type of digital asset including receiving respective user method data for each respective balancing determining method to be used to determine a total amount of the particular type of digital asset.

7. The computing device of claim 1, wherein the threshold amount is a count of instances of the particular type of digital asset or an equivalent currency value thereof.

8. The computing device of claim 1, wherein the access management controls access to an on-line service comprising a chat room service.

9. The computing device of claim 8, wherein the chat room service provides services responsive to topics, the topics comprising types of digital assets and wherein the access management controls access to a chat room service associated with the particular type of digital asset.

10. The computing device of claim 9, wherein the access management controls access to a function associated with the particular type of digital asset, the function comprising any of:
adding a new chat room associated with the particular type of digital asset;
adding a new conversation in a chat room associated with the particular type of digital asset; and
replying to a conversation associated with the particular type of digital asset.

11. The computing device of claim 1, wherein the threshold amount of the particular type of digital asset is a first threshold amount of a first particular type, wherein the user credential information further includes information to indicate that the user is a provable holder of a second threshold amount of a second particular type of digital asset and wherein access management provides or denies access to the user in accordance with whether the user holds respective threshold amounts of one, the other or both of the first particular type and second particular type of digital asset.

12. The computing device of claim 1, wherein the particular type of digital asset is a particular type of cryptocurrency or a particular type of non-fungible token (NFT).

13. A computer-implemented method comprising:
performing access management to control on-line access to an on-line service or physical access to a secured location, the access management providing or denying access to a user in accordance with user credential information determined for the user, the user credential information indicating that the user is a provable holder of a threshold amount of a particular type of digital asset.

14. The method of claim 13 comprising determining the user credential information by obtaining digital asset balance information for instances of the particular type of digital asset stored to a blockchain by or on behalf of the user.

15. The method of claim 14, comprising, any of:
obtaining the digital asset balance information and determining the user credential information periodically; and
obtaining the digital asset balance information and determining the user credential information in response to a request for access received.

16. The method of claim 14, comprising obtaining the digital asset balance information using respective balance determining methods as enrolled by the user and respective user method data for each of the respective balance determining methods as enrolled.

17. The method of claim 16, wherein the respective balance determining methods comprise any of:
a software wallet method to determine digital asset balance information from one or more accounts maintained by the user using a software wallet and wherein the respective user method data comprises software wallet information for the user;
a hardware wallet method to determine digital asset balance information from one or more accounts maintained by the user using a hardware wallet and wherein the respective user method data comprises hardware wallet information for the user;
a web3 wallet method to determine digital asset balance information from one or more accounts maintained by the user using a web3 wallet and wherein the respective user method data comprises web3 wallet information for the user;
a first exchange service method to determine digital asset balance information from one or more accounts maintained by the user using a first exchange service, the first exchange service having an API and wherein the respective user method data comprises first exchange service information for the user; and
a second exchange service method to determine digital asset balance information from one or more accounts maintained by the user using a second exchange service, the second exchange service not having an API and wherein the respective user method data comprises second exchange service information for the user.

18. The method of claim 13 comprising enrolling the user in association with the particular type of digital asset including receiving respective user method data for each respective balancing determining method to be used to determine a total amount of the particular type of digital asset.

19. The method of claim 13, wherein the threshold amount is a count of instances of the particular type of digital asset or an equivalent currency value thereof.

20. The method of claim 13, wherein the access management controls access to an on-line service comprising a chat room service.

21. The method of claim 20, wherein the chat room service provides services responsive to topics, the topics comprising types of digital assets and wherein the access management controls access to a chat room service associated with the particular type of digital asset.

22. The method of claim 21, wherein the access management controls access to a function associated with the particular type of digital asset, the function comprising any of:
adding a new chat room associated with the particular type of digital asset;
adding a new conversation in a chat room associated with the particular type of digital asset; and
replying to a conversation associated with the particular type of digital asset.

23. The method of claim 13, wherein the threshold amount of the particular type of digital asset is a first threshold amount of a first particular type, wherein the user credential information further includes information to indicate that the user is a provable holder of a second threshold amount of a second particular type of digital asset and wherein access management provides or denies access to the user in accordance with whether the user holds respective threshold amounts of one, the other or both of the first particular type and second particular type of digital asset.

24. The method of claim 13, wherein the particular type of digital asset is a particular type of cryptocurrency or a particular type of non-fungible token (NFT).

25. A computer program product comprising a non-transitory storage device storing instructions which, when executed by a processor of a computing device, configure the computing device to:
perform access management to control on-line access to an on-line service or physical access to a secured location, the access management providing or denying access to a user in accordance with user credential information determined for the user, the user credential information indicating that the user is a provable holder of a threshold amount of a particular type of digital asset.
